(19) United States
(12) Patent Application Publication
(10) Pub. No.: US 2007/0247025 A1
(43) Pub. Date: Oct. 25, 2007

(54) Piezoactuator

(76) Inventors: Giacomo Sciortino, Osnabrueck (DE); Christopher A. Goat, Offham (GB)

Correspondence Address: DELPHI TECHNOLOGIES, INC., M/C 480-410-202, PO BOX 5052, TROY, MI, 48007, US

(21) Appl. No.: 11/643,521

(22) Filed: Dec. 21, 2006

(30) Foreign Application Priority Data
Dec. 23, 2005 (EP) 05028439.7

(51) Int. Cl. H02N 2/04

(52) U.S. Cl. 310/328; 29/25.35

(57) ABSTRACT

a piezoactuator having at least one outer surface comprises a multilayer structure of at least one piezoelectric ceramic layer and at least two electrodes, with the at least one outer surface of the piezoactuator being coated with a passivation material.

### TECHNICAL FIELD

The present invention relates to a piezoelectric component, in particular to a piezoactuator, having at least one external surface and comprising a multilayer structure of at least one piezoelectric ceramic layer and at least two electrodes. The present invention furthermore relates to a method of manufacturing a piezoactuator.

### BACKGROUND OF THE INVENTION

Known piezoactuators typically have a stack of alternating (inner) electrodes and piezoceramic layers, with the individual inner electrodes being surrounded at both sides by a piezoceramic layer in each case and the individual piezoceramic layers - with the exception of the ones arranged at the margin of the stack - being surrounded at both sides by an inner electrode in each case. In this connection, respectively adjacent inner electrodes separated from one another by a piezoceramic layer have different polarities; for example, the first, third and fifth inner electrodes of the stack have a positive polarity and the second, fourth and sixth inner electrodes of the stack have a negative polarity so that, when an electrical voltage is applied between two respective adjacent inner electrodes, a respective electrical field is formed. This is achieved from a construction aspect, for example, in that a respective end of every second inner electrode is electrically conductively connected to a metal layer functioning as a first outer electrode and applied to a first side surface of the piezoactuator which is of parallelepiped shape as a rule, whereas a respective end of the other inner electrodes is in contact with a metal layer applied to a second side surface of the piezoactuator disposed opposite the first and acting as a second outer electrode. By application of an electrical voltage to these two outer electrodes, the individual inner electrodes are thus alternately polarized so that every individual piezoceramic layer which is arranged between two inner electrodes of different polarity is exposed to an electrical field. A multiplication of the usable longitudinal extent of the individual layers is achieved by the stack-like arrangement of the individual piezoceramic layers and of the inner electrode layers so that displacements of up to 500 μm can be reached in dependence on the number of piezoceramic layers.

To avoid an electrical short circuit on the application of an electrical voltage with the aforesaid arrangement of the inner electrodes, the individual inner electrodes and outer electrodes of different polarity must be electrically insulated from one another. To avoid a short circuit between the inner electrodes of a first polarity and the outer electrode of opposite polarity, the individual inner electrodes typically do not extend beyond the total width of the cross-section plane bounded by the two side surfaces provided with one respective outer electrode each, but—starting from the side surface having the outer electrode of the same polarity to which the inner electrode is connected—only up to a specific spacing from the oppositely disposed side surface on which the second outer electrode of opposite polarity is arranged. A respective axially extending marginal region is thereby formed at each of the two side surfaces provided in each case with an outer electrode and only inner electrodes of one polarity are located therein. In these marginal regions, when an electrical voltage is applied between the outer electrodes, no electrical field is consequently generated so that these marginal layers are piezoelectrically inactive.

To restrict these piezoelectrically inactive regions to the axial marginal regions of the two side surfaces with an outer electrode arranged thereon, the individual inner electrodes extend in the transverse direction thereto, that is in a throughgoing manner from a side wall without an outer electrode to the side wall disposed opposite to it so that the individual inner electrodes extend up to the two surfaces of the side surfaces of the piezoactuator having no outer electrode and are exposed there. To avoid an electrical short circuit at these side areas between adjacent electrodes of different polarity, these two side surfaces are typically provided with a flexible dielectric coating of a suitable passivation material, with coatings being used for this purpose of, for example, silicone rubber or fluorocarbon resins.

However, the insulation properties of the known passivation materials are not sufficient for all applications of piezoactuators. When piezoactuators are used to open and close injection valves in diesel engines, for example, the piezoelectric components are exposed to temperatures of up to 150° C. and to injection pressures of 200 to 2,000 bar. The passivation materials used for this purpose, for example fluoropolymers, admittedly have a comparatively low permeability for fuel and moisture, but are nevertheless completely impermeable neither for fuel nor for moisture. In particular when the moisture content of the fuel amounts to more than 200 ppm, there is a risk with the known passivation materials that moisture will diffuse through the passivation layer and cause an electrical short circuit in particular at the side surfaces at which adjacent electrodes of different polarity are exposed.

### SUMMARY OF THE INVENTION

It is therefore the object of the present invention to provide a piezoelectric component which is in particular impermeable to fuel and to water even at high temperatures and simultaneously high pressures and is therefore in particular suitable for the control of an injection valve in a diesel engine.

In accordance with the invention, this object is satisfied by a piezoelectric component having the features of claim 1 and in particular by a piezoelectric component, in particular a piezoactuator, having at least one outer surface and comprising a multilayer structure of at least one piezoelectric ceramic layer and at least two electrodes, with the at least one outer surface of the component being coated with a passivation material which consists at least partly of glass.

It was surprisingly able to be discovered within the framework of the present invention that glass, which is brittle and prone to breaking per se, is exceptional as passivation material for a piezoelectric component subject to dimensional changes during its operation, in particular when it is ensured that the coating of passivation material is permanently under compression during the operation of the piezoelectric component. In addition, it was able to be discovered within the framework of the present invention that glass is not only chemically resistant to fuel and moisture, but is sufficiently impermeable to these compounds, in particular also at the high temperatures prevailing in injection systems in diesel engines. Moreover, a coating of glass also has sufficient dielectric properties to achieve good electrical insulation of the surfaces coated therewith. Exceptional insulation of piezoelectric components can thus be achieved with the passivation material made from glass to be used in accordance with the invention by coating in particular those side surfaces of a piezoactuator at which the inner electrodes of different polarity are exposed.

Advantageous embodiments of the invention are described in the description, in the drawings and in the dependent claims.

To avoid crack formation in the passivation material during the operation of the piezoelectric component, it is proposed in a further development of the idea of the invention to provide a passivation material which has a lower coefficient of thermal expansion than the piezoelectric component coated therewith. It is thereby ensured that the passivation material is in compression on the component.

Good results are in particular obtained with passivation materials which have a coefficient of thermal expansion (measured at 20° C.) of less than 10×10⁻⁻⁶/K. The coefficient of thermal expansion of the passivation material to be used in accordance with the invention preferably amounts to less than 7.5×10⁻⁶/K, particularly preferably to less than 5×10⁻⁶/K and very particularly preferably to less than 4×10⁻⁶/K.

In addition, it has proven to be advantageous within the framework of the present invention for the passivation material to have a glass transition temperature of at least 250° C., preferably of at least 350° C., particularly preferably of at least 450° C. and very particularly preferably of at least 500° C.

Glass materials which satisfy the aforesaid criteria exceptionally are in particular borosilicate glass and quartz glass. It is preferred for this reason for the passivation material to contain borosilicate glass and/or quartz glass. Particularly good results are obtained when the passivation material consists of one of the aforesaid compounds or of a mixture of the two aforesaid compounds. Borosilicate glasses are characterized, for example, by a low coefficient of thermal expansion in the range of 3×10⁻⁶/K and by a high resistance capability with respect to chemicals, in particular with respect to fuel and water, even at high temperatures and pressures. In addition, borosilicate glasses have an exceptional heat resistance at 0.24 N/mm²K so that they are sufficiently resistant to temperature variations and thermal shock. According to the findings of the present invention, quartz glass also has similarly exceptional properties as a passivation material.

In a further development of the idea of the invention, it is proposed to provide borosilicate glass in the passivation material which contains 65 to 85% by weight SiO₂, 5 to 25% by weight B₂O₃ and 0 to 15% by weight of at least one compound selected from the group consisting of Na₂O, K₂O, CaO, MgO, Al₂O₃, PbO and any desired combinations thereof.

Particularly good results were in particular obtained with borosilicate glasses free of alkaline earth metals which have a particularly high resistance capability to chemicals and a particularly low coefficient of thermal expansion. Typically, borosilicate glasses free of alkaline earth metals contain 12 to 13% by weight B₂O₃ and at least 80% by weight SiO₂. An example for a commercially available borosilicate glass from this group is Duran® from Schott, Mainz, Germany.

A further subject of the present invention is a piezoelectric component, in particular a piezoactuator, comprising a multilayer structure of at least two piezoelectric ceramic layers and at least two inner electrodes, with the individual piezoelectric ceramic layers and the individual inner electrodes being arranged alternately over one another in the form of a stack—in which, with the exception of the upper and lower marginal layers of the stack, one respective piezoelectric ceramic layer being surrounded by two inner electrodes and one respective inner electrode being surrounded by two piezoelectric ceramic layers—and the individual inner electrodes extending at least regionally up to at least one of the side surfaces of the component. To avoid an electrical short circuit between two adjacent inner electrodes separated from one another by a piezoelectric ceramic layer, provision is made in accordance with the invention for at least one of the side surfaces up to which the individual inner electrodes extend at least regionally to be coated with a passivation material in accordance with the invention which consists at least partly of glass.

Typically, respectively alternate inner electrodes of a piezoelectric component, in particular a piezoactuator, which—as shown for example in FIG. 1—is as a rule made in parallelepiped form, have different polarities. For this reason, the first, third, fifth, seventh, etc. inner electrodes are connected to a first outer electrode which is arranged at a first side surface of the component and is connected, for example, to the positive pole of a power source, whereas the second, fourth, sixth, eighth, etc. inner electrodes are connected to a second outer electrode which is arranged at the side surface disposed opposite the first side surface and which is connected, for example, to the negative pole of a power source. To prevent an electrical short circuit between the outer electrodes and the inner electrodes poled differently in comparison with them, the individual inner electrodes do not extend over the whole width of the cross-sectional plane defined by the two side walls each having an outer electrode, but from the side surface with the outer electrode of the same polarity only up to a certain spacing from the oppositely disposed side surface of the component. Piezoelectrically inactive marginal regions in which in each case only inner electrodes of one polarity are present are thereby formed in the two marginal regions of the two side surfaces with outer electrodes. In contrast, the inner electrodes of conventional piezoelectric components extend between the two other side surfaces which have no outer electrodes over the total width of the cross-sectional plane so that the inner electrodes of different polarity at the surfaces of the corresponding side surfaces are exposed—separated from one another only by a piezoelectric ceramic layer disposed therebetween. To reliably avoid an electrical short circuit, in particular at these side surfaces, and indeed in particular also at high temperatures and/or high pressures, it is proposed in a further development of the idea of the invention to coat at least the two side surfaces which have no outer electrode with a passivation material which consists at least partly of glass.

In accordance with a special embodiment of the present invention, the piezoelectric component is a common rail actuator.

Furthermore, the present invention relates to a method of manufacturing a piezoelectric component, in particular a piezoactuator, in which at least one outer surface of the component is coated with a passivation material in accordance with the invention.

It is proposed in a further development of the idea of the invention to coat the at least one side surface of the component with a passivation material which contains borosilicate glass and/or quartz glass or consists of borosilicate glass and/or of quartz glass. Due to the low coefficient of thermal expansion and the good resistance capability with respect to chemicals of the two aforesaid materials, crack formations in the passivation layer can be reliably avoided in the operation of the component.

In this connection, the application of the passivation material to the at least one outer surface can take place with any method familiar to the skilled person. If the passivation material contains quartz glass or consists of quartz glass, this is preferably carried out by evaporation of a silane compound onto the at least one outer surface of the component at a temperature at which the silane compound decomposes thermally to form silica. For this purpose, all known silane compounds can be used which are sufficiently thermally instable and decompose to form silica at corresponding temperatures. Tetra-alkoxysilanes, tetra-alkylsilanes and dihalogen silanes are named by way of example only. Preferred silane compounds are in particular tetra-ethoxy-silane (TEOS) and dichlorsilane.

When evaporating the two last-named compounds onto the surface of the piezoelectric component to be coated at, for example, 1,100° C., the TEOS or dichlorsilane decomposes to form silica in accordance with the following equations:
Si(C₂H₅O)₄→SiO₂+2H₂O+4C₂H₄
2SiH₂Cl₂+2NO₂→2SiO₂+4HCl+N₂.

A problem with the conventional piezoelectric compounds can be found in the fact that the components are prone to breaking in the region of the piezoelectrically inactive marginal regions. This is due to the fact that only electrodes of one polarity are present in these marginal regions so that no electrical field is formed at the polarity in these regions so that the crystallites are not poled in these regions. A break in these regions of the piezoelectric components, however, necessarily also results in a mechanical strain on the coating of passivation material, which can result in crack formation in the passivation material. To prevent this, in accordance with a special embodiment of the present invention, it is proposed to pole the piezoelectric component in two different steps during its manufacture in order to achieve at least a specific orientation of the crystallites in the marginal region. This can be achieved, for example, by a method comprising the following steps:
a) making available of a parent substance of a piezoelectric component of a multilayer structure of at least one piezoelectric ceramic layer and at least two electrodes, with the at least one piezoelectric ceramic layer and the individual electrodes being arranged disposed alternately over one another in the form of a stack;
b) grinding of two oppositely disposed side surfaces of the parent substance until the ends of the electrodes extend up to the surface of the two side surfaces and are exposed there;
c) coating of the parent substance with a passivation material which at least partly consists of glass;
d) grinding of the other two oppositely disposed side surfaces of the parent substance not ground in step b), whereby the passivation material on these two side surfaces is again removed;
e) carrying out of a first poling while applying an electrical field between the top surface and the base surface of the multilayer structure;
f) applying of one outer electrode each onto the two side surfaces ground in step d); and
g) carrying out of a second poling by application of electrical voltage to the two outer electrodes.

In that a voltage is applied in step e) during the first poling between the top surface and the base surface of the multilayer structure, a uniform electric field is formed over the total cross-sectional surface of the piezoelectric component, that is also in particular in the axial marginal regions of the side surfaces, whereby the piezoelectric ceramic material in the marginal regions is also poled at least to a specific degree. A more uniform orientation of the crystallites is thus achieved, viewed over the cross-sectional surface of the component, such that the proneness to breaking at the marginal regions of the piezoelectric component is reduced. The carrying out of the first and second poling in accordance with the features e) and g) is described in detail in WO 03/105247, which is herewith introduced as a reference and is deemed to be part of the disclosure.

The application of the outer electrodes preferably takes place on the two side surfaces in accordance with step f) by metal deposition from the gas phase at a temperature beneath the Curie temperature of the piezoelectric ceramic material. This deposition can take place, for example, using the sputtering technique or by arc evaporation.

The second poling in accordance with step g) of the method can take place directly after application of the two outer electrodes in accordance with step f) or also at a later point in time. The second poling is preferably carried out only after the complete assembly of the piezoelectric component since the component is best protected with respect to damaging influences at this point in time. It has in particular proved to be advantageous to carry out the second poling hydrostatically to ensure that the whole component remains in compression in the second poling.

In the case of a piezoactuator for use in an injection system, the second poling preferably takes place after the installation of the piezoactuator into the injector.

### BRIEF DESCRIPTION OF THE DRAWINGS

The present invention will be described in the following purely by way of example with reference to advantageous embodiments and to the enclosed drawings. There are shown:

FIG. 1 is a perspective view of a piezoactuator with passivation coatings; and

FIG. 2 is a diagram showing the dependence of the stretching of a piezoelectric component in dependence on the temperature.

### DESCRIPTION OF THE PREFERRED EMBODIMENT

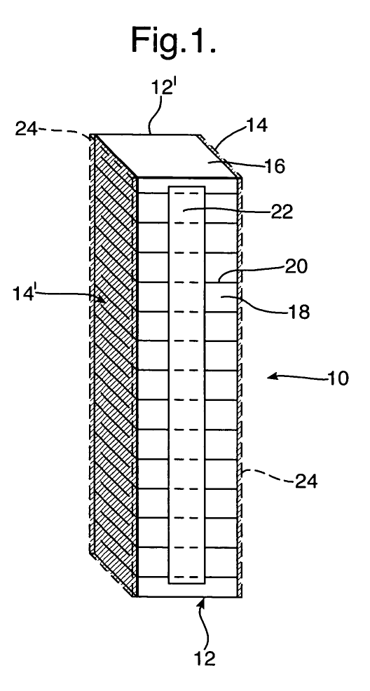

The piezoactuator 10 shown schematically in FIG. 1 is made in parallelepiped form and comprises a plurality of alternately arranged layers, which combine to define four side surfaces 12, 12′, 14, 14′, a base surface and a top surface 16. Piezoactuator 10 consists of alternately arranged layers of piezoelectric ceramic material 18 and inner electrodes 20, with the individual layers 18, 20 being arranged disposed over one another in the form of a stack and—with the exception of the topmost and bottommost layers—a respective piezoelectric ceramic layer 18 being surrounded by two inner electrodes 20 and each inner electrode 20 being surrounded by two respective piezoelectric ceramic layers 18.

An outer electrode 22, consisting of a metal layer, is in each case provided at the two oppositely disposed side surfaces 12, 12′ of the parallelepiped-shaped piezoactuator 10. The individual inner electrodes 20 are connected in each case alternately—viewed from the bottom to the top—to one of the two outer electrodes 22. The first, third, fifth, etc. inner electrodes 20 viewed from below are thus connected to the outer electrode 22 applied to the side surface 12, whereas the second, fourth, sixth, etc. inner electrodes 20 are connected to the outer electrode arranged at the side surface 12′ disposed opposite the side surface 12. By application of an electric voltage to the two outer electrodes 22, electrical fields can be formed between the individual inner electrodes 20 of the piezoelectric component 10, with the individual electrical fields at two adjacent piezoelectric ceramic layers 18 being differently oriented in each case due to the alternating polarities of the inner electrodes 20.

To prevent an electrical short circuit between the individual inner electrodes 20 and the respectively oppositely poled outer electrodes 22, the individual inner electrodes 20, starting from the respective outer electrode 22 to which they are connected, do not extend in a throughgoing manner up to the side surface 12, 12′ disposed opposite the corresponding outer electrode 22 with the oppositely polarized outer electrode 22, but end—as can be seen on the side surface 18′ of FIG. 1—at a specific spacing herefrom. Due to the alternating arrangement of the inner electrodes 20, axially extending marginal regions are therefore formed at the side surfaces 12, 12′ and only electrodes of one polarity are in each case present in them.

In contrast, the individual electrodes 20 extend in the plane defined by the two other side surfaces 14, 14′ which are not provided with an outer electrode 22 so that the individual inner electrodes 20 are exposed on the surfaces of the side surfaces 14, 14′, with in each case two adjacent inner electrodes 20 having a different polarity. To avoid an electrical short circuit between the individual inner electrodes 20 of different polarity lying exposed on the surfaces of the side surfaces 14, 14′, a coating 24 of passivation material, that consists at least partly of glass, is in each case provided on the two side surfaces 14, 14′. The coatings 24 on the side surfaces 14, 14′ are shown hatched and with broken lines in FIG. 1.

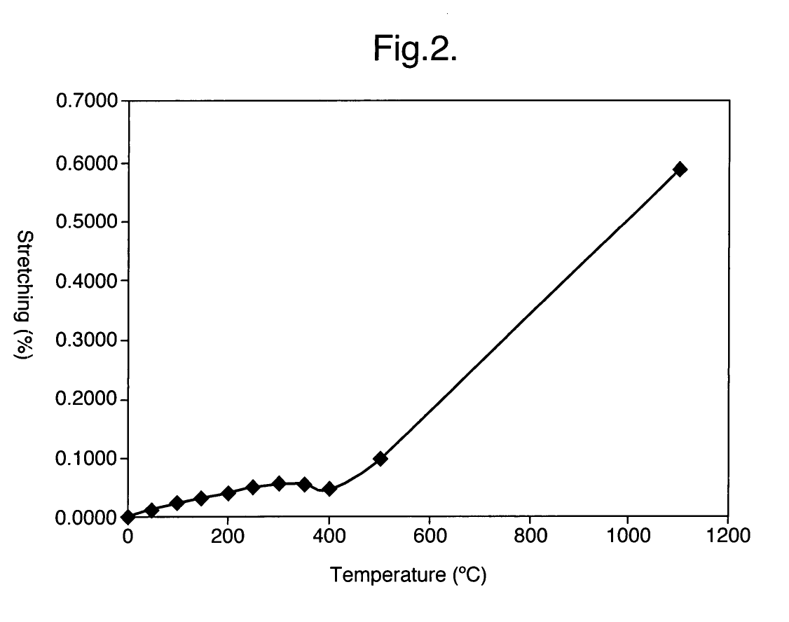

In FIG. 2, the thermal expansion of a conventional piezoactuator 10 not having any passivation layer in accordance with the invention is shown in dependence on the temperature. As can be seen from the diagram, a conventional piezoactuator 10 expands by 0.59% on heating from 0° C. to 1,100° C. and contracts by the same factor on cooling from 1,100° C. to 0° C.

In comparison with the piezoactuator 10, the passivation material of glass used in accordance with the invention has a significantly lower coefficient of thermal expansion which amounts for borosilicate glass, for example, to approximately 3×10⁻⁶/K. If the passivation material was, for example, applied to the piezoactuator 10 by gas phase deposition at 1,100° C., the glass coating therefore undergoes a compression of 0.59% on cooling from 1,100° C. to 0° C.

During the poling of the piezoactuator 10, the maximum stretching of the component 10 along the poling axis amounts to approximately 0.2%, with the residual stretching after the poling amount to approximately 0.11%. If now a coating of glass passivation material to be used in accordance with the invention was applied to the side surfaces 14, 14′ of the piezoactuator 10 at 1,100° C., the glass coating remains under compression during the whole poling process due to the different coefficient of thermal expansion and ends at a compression of approximately 0.48% at the end of the poling process in accordance with the stretching caused by different thermal coefficients of expansion less the remaining residual stretching after the poling.

During the operation of the piezoactuator 10 in an injection system of a diesel engine, the piezoactuator 10 is subject to an injection pressure which compresses both the ceramic multilayer arrangement and the glass passivation layer. At 200 bar, the ceramic material is compressed by 0.023%, whereas the compression amounts to approximately 0.23% at 2,000 bar. Consequently, the glass passivation layer on a poled piezoactuator 10 is subject to a compression of approximately 0.48% at 200 bar and to a compression of approximately 0.71% at 2,000 bar.

If the piezoactuator 10 coated with the passivation layer is set to a displacement or stroke of 100 μm by application of a corresponding electrical voltage, a longitudinally extending stretching results of approximately 0.125% which is significantly lower than the compression caused by the different thermal coefficients of expansion and the operating pressure. As a result of this, the passivation layer remains in compression at all pressures, with the compression amounting to approximately 0.35% on average. Cracks in the passivation layer 24 on the operation of the piezoactuator 10 are thereby reliably avoided.

In addition, an electrical short-circuit in a piezoelectric component, in particular on the side surfaces on which electrodes of different polarity are exposed, is reliably prevented by the passivation material to be used in accordance with the invention which consists at least partly of glass. The good resistance of glass with respect to chemicals, in particular fuel and water, and the low coefficient of thermal expansion of glass have a particularly advantageous effect in this connection. In addition, glass can be bound firmly to a piezoelectric component due to its excellent bonding capability. Furthermore, the comparatively thin glass layer permits an effective heat transport from the piezoelectric component to the medium surrounding it, for example fuel in an injection system.

1. A piezoactuator comprising:
a multilayer structure comprising at least one piezoelectric ceramic layer and at least two electrodes;
wherein at least one of the electrodes defines at least one outer surface; and
wherein the at least one outer surface is coated with a passivation material comprising glass.

2. A piezoactuator in accordance with claim 1, wherein the passivation material has a coefficient of thermal expansion that is lower than the coefficient of thermal expansion of the outer surface.

3. A piezoactuator in accordance with claim 1, wherein the passivation material has a coefficient of thermal expansion that is less than 10×10⁻⁶/K when measured at 20° C.

4. A piezoactuator in accordance with claim 1, wherein the passivation material has a coefficient of thermal expansion that is less than 7.5×10⁻⁶/K when measured at 20° C.

5. A piezoactuator in accordance with claim 1, wherein the passivation material has a coefficient of thermal expansion that is less than 5×10⁻⁶/K when measured at 20° C.

6. A piezoactuator in accordance with claim 1, wherein the passivation material has a coefficient of thermal expansion that is less than 4×10⁻⁶/K when measured at 20° C.

7. A piezoactuator in accordance with claim 1, wherein the passivation material has a glass transition temperature of at least 250° C.

8. A piezoactuator in accordance with claim 1, wherein the passivation material has a glass transition temperature of at least 350° C.

9. A piezoactuator in accordance with claim 1, wherein the passivation material has a glass transition temperature of at least 450° C.

10. A piezoactuator in accordance with claim 1, wherein the passivation material has a glass transition temperature of at least 500° C.

11. A piezoactuator in accordance with claim 1, wherein the passivation material comprises borosilicate glass.

12. A piezoactuator in accordance with claim 1, wherein the passivation material comprises quartz glass.

13. A piezoactuator in accordance with claim 1, wherein the passivation material comprises borosilicate glass and quartz glass.

14. A piezoactuator in accordance with claim 11, wherein the borosilicate glass contains 65 to 85% by weight SiO₂, 5 to 25% by weight B₂O₃ and 0 to 15% by weight of at least one compound selected from the group consisting of Na₂O, K₂O, CaO, MgO, Al₂O₃, PbO and any desired combinations thereof.

15. A piezoactuator comprising a multilayer structure of at least two piezoelectric ceramic layers and at least two inner electrodes; wherein the individual piezoelectric ceramic layers and the individual inner electrodes are arranged alternately lying above one another in the form of a stack; wherein the individual inner electrodes extend at least regionally up to at least one side surface of the piezoactuator; and wherein at least one of the side surfaces of the piezoactuator, up to which the individual inner electrodes extend, at least regionally, is coated with a passivation material comprising glass.

16. A piezoactuator in accordance with claim 15, wherein the piezoactuator is formed in a substantially parallelepiped form, wherein two oppositely disposed side surfaces of the four side surfaces of the piezoactuator each have one outer electrode which are connected to the inner electrodes, and wherein at least the two other side surfaces of the piezoactuator are coated with a passivation material comprising glass.

17. A piezoactuator in accordance with claim 1, wherein said piezoactuator is adapted for use as a common rail actuator.

18. A method of manufacturing a piezoactuator comprising the steps of:
a) providing a parent substance of a piezoactuator of a multilayer structure of at least one piezoelectric ceramic layer and at least two electrodes, with the at least one piezoelectric ceramic layer and the individual electrodes being arranged disposed alternately over one another in the form of a stack;
b) grinding two oppositely disposed side surfaces of the parent substance until the ends of the electrodes extend up to the surface of the two side surfaces and are exposed there;
c) coating the parent substance with a passivation material which at least partly consists of glass;
d) grinding the other two oppositely disposed side surfaces of the parent substance not ground in step b), whereby the passivation material on these two side surfaces is again removed;
e) performing a first poling while applying an electrical field between the top surface and the base surface of the multilayer structure;
f) applying one outer electrode each onto the two side surfaces ground in step d); and
g) performing a second poling by application of electrical voltage to the two outer electrodes.

19. A method in accordance with claim 18 wherein at least one outer surface of the piezoactuator comprising a passivation material comprising glass.

20. A method in accordance with claim 18, wherein the passivation material contains quartz glass.

21. A method in accordance with claim 20, wherein the quartz glass is applied by evaporation of a silane compound onto the at least one outer surface of the piezoactuator.

22. A method in accordance with claim 21, wherein the silane compound is a tetra-alkoxysilane.

23. A method in accordance with claim 21, wherein the silane compound is a tetra-alkyl-silane.

24. A method in accordance with claim 21, wherein the silane compound is a dihalogen silane.

25. A method in accordance with claim 21, wherein the silane compound is a tetra-ethoxy-silane.

26. A method in accordance with claim 21, wherein the silane compound is a dichlorsilane.
